(19) United States
(12) Patent Application Publication
(10) Pub. No.: US 2025/0079480 A1
(43) Pub. Date: Mar. 6, 2025

(54) FUEL CELL COOLING UNIT

(71) Applicant: TOYOTA JIDOSHA KABUSHIKI KAISHA, Toyota-shi Aichi-ken (JP)

(72) Inventors: Hiromichi SATO, Hadano-shi Kanagawa-ken (JP); Satoshi AOYAMA, Susono-shi Shizuoka-ken (JP)

(73) Assignee: TOYOTA JIDOSHA KABUSHIKI KAISHA, Toyota-shi Aichi-ken (JP)

(21) Appl. No.: 18/812,480

(22) Filed: Aug. 22, 2024

(30) Foreign Application Priority Data
Sep. 4, 2023 (JP) 2023-143167

(51) Int. Cl. H01M 8/04029; H01M 8/04007

(52) U.S. Cl. CPC H01M 8/04029; H01M 8/04067; H01M 2250/20

(57) ABSTRACT

A fuel cell cooling unit, may include a first refrigerant circulation path in which refrigerant circulates, a fuel cell configured to be cooled by the refrigerant flowing in the first refrigerant circulation path; and a heat exchanger. The heat exchanger may include a first path and a second path, the first path being a part of the first refrigerant circulation path, and the heat exchanger being configured to exchange heat between the first path and the second path. A connection structure allowing a pipe to be connected and disconnected may be provided at each of an upstream end and a downstream end of the second path.

### CROSS-REFERENCE TO RELATED APPLICATIONS

This application claims priority to Japanese Patent Application No. 2023-143167 filed on Sep. 4, 2023, the contents of which are hereby incorporated by reference into the present application.

### TECHNICAL FIELD

The technology disclosed herein relates to a fuel cell cooling unit.

A fuel cell cooling system is known in which the fuel cell is cooled by a radiator. This type of fuel cell cooling system has a refrigerant circulation path through which refrigerant circulates. The refrigerant cooled by the radiator is supplied to the fuel cell via the refrigerant circulation path, thereby cooling the fuel cell. To ensure insulation between the fuel cell and the radiator, a material with low electrical conductivity is used as the refrigerant.

### DESCRIPTION OF RELATED ART

Japanese Patent Application Publication No. 2022-98553 describes a fuel cell cooling system with independent refrigerant circulation paths on the fuel cell side (hereinafter referred to as a first refrigerant circulation path) and on the radiator side (hereinafter referred to as a second refrigerant circulation path). This fuel cell cooling system has a heat exchanger that exchanges heat between the first refrigerant circulation path and the second refrigerant circulation path. According to this configuration, the insulation between the fuel cell and the radiator can be higher.

### BRIEF SUMMARY

Conventionally, a fuel cell cooling system from a radiator to a fuel cell is provided by a manufacturer as an integrated unit. However, with this type of provision, it may be difficult to respond to the diversification of fuel cell usage. This disclosure proposes a technology that enables a fuel cell cooling system to be used in more diverse forms.

A fuel cell cooling unit may comprise a first refrigerant circulation path in which refrigerant circulates, a fuel cell configured to be cooled by the refrigerant flowing in the first refrigerant circulation path; and a heat exchanger comprising a first path and a second path, the first path being a part of the first refrigerant circulation path, and the heat exchanger being configured to exchange heat between the first path and the second path. A connection structure allowing a pipe to be connected and disconnected may be provided at each of an upstream end and a downstream end of the second path.

In this fuel cell cooling unit, the user can use the fuel cell cooling unit by connecting a second refrigerant circulation path (i.e., a refrigerant circulation path on the radiator side) to the second path. In other words, in this configuration, the user can prepare the second refrigerant circulation path. Since the first path being a part of the first refrigerant circulation path and the second path being a part of the second refrigerant circulation path are independent, insulation is ensured between the first and second refrigerant circulation paths. Therefore, the user can connect the second refrigerant circulation path to the fuel cell cooling unit without considering the insulation of the second refrigerant circulation path. In addition, since the first and second paths are independent, the pressure distribution in the second refrigerant circulation path does not affect the pressure distribution in the first refrigerant circulation path. Therefore, the user can connect the second refrigerant circulation path to the fuel cell cooling unit without considering the pressure distribution in the first refrigerant circulation path. Thus, the user can install the second refrigerant circulation path without any restrictions due to insulation or pressure distribution in the first refrigerant circulation path. Therefore, according to this fuel cell cooling unit, a fuel cell cooling system can be constructed in a variety of forms.

Further proposed herein is a fuel cell cooling system in which the conductivity of the refrigerant is easily managed. A second fuel cell cooling system may comprise: a first refrigerant circulation path in which refrigerant circulates; a fuel cell configured to be cooled by the refrigerant flowing in the first refrigerant circulation path; a second refrigerant circulation path in which refrigerant circulates; a radiator configured to cool the refrigerant flowing in the second refrigerant circulation path; and a heat exchanger comprising a first path and a second path, the first path being a part of the first refrigerant circulation path, the second path being a part of the second refrigerant circulation path, and the heat exchanger being configured to exchange heat between the first path and the second path. Electrical conductivity of the refrigerant in the second refrigerant circulation path may be higher than electrical conductivity of the refrigerant in the first refrigerant circulation path.

In this fuel cell cooling system, insulation between the fuel cell and the second refrigerant circulation path is ensured by the independence of the first and second refrigerant circulation paths and the low conductivity of the refrigerant in the first refrigerant circulation path. Therefore, even if the conductivity of the refrigerant in the second refrigerant circulation path is high, insulation between the radiator and the fuel cell is ensured. In addition, since there is no problem even if the conductivity of the refrigerant in the second refrigerant circulation path is high, no process is needed to reduce the conductivity of the refrigerant in the second refrigerant circulation path (e.g., to remove ions from within the refrigerant). Therefore, in this fuel cell cooling system, the conductivity of the refrigerant is easy to manage.

### BRIEF DESCRIPTION OF DRAWINGS

FIG. 1 illustrates a fuel cell cooling system 100.

FIG. 2 illustrates connection of a pump 50 and a heat exchanger 30.

FIG. 3 illustrates a fuel cell cooling system of a variant.

### DETAILED DESCRIPTION

The fuel cell cooling unit or fuel cell cooling system described above may comprise a parallel path connected in parallel to a fuel cell path which is a portion of the first refrigerant circulation path extending through the fuel cell; and an ion exchanger configured to remove ions from the refrigerant in the parallel path. The refrigerant may flow in the fuel cell path and the parallel path whenever the refrigerant is circulating in the first refrigerant circulation path.

This configuration prevents an increase in the conductivity of the refrigerant in the first refrigerant circulation path.

The fuel cell cooling unit or fuel cell cooling system described above may further comprising a pump configured to circulate the refrigerant in the first refrigerant circulation path. A discharge port of the pump is connected to an upstream end of the first path by a flange connection

According to this configuration, the connection strength at the discharge port of the pump is improved, which allows for higher pump discharge pressure.

The fuel cell cooling unit or fuel cell cooling system described above may further comprise a bypass path connecting an upstream portion of the second path with respect to the heat exchanger and a downstream portion of the second path with respect to the heat exchanger; and an intercooler provided in the bypass path and configured to cool air supplied to the fuel cell.

This configuration prevents elution of ions from the intercooler into the refrigerant in the first refrigerant circulation path.

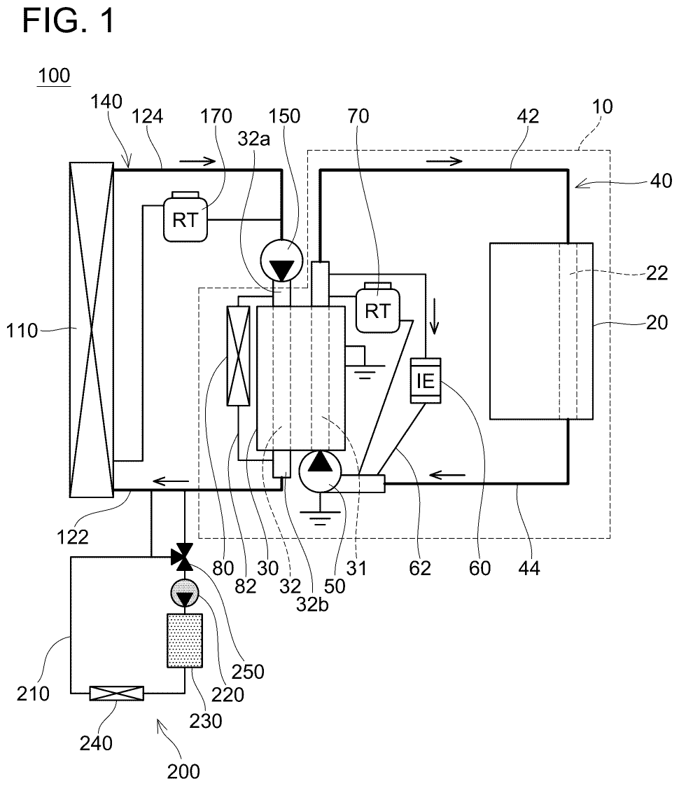

A fuel cell cooling unit 10 illustrated in FIG. 1 is incorporated in a fuel cell cooling system 100. The fuel cell cooling unit 10 has a fuel cell 20. The fuel cell cooling system 100 is mounted on an electric vehicle. Hydrogen is supplied to the fuel cell 20 from a tank (not illustrated) and compressed air is supplied to the fuel cell 20 from a compressor (not illustrated). The fuel cell 20 reacts with the hydrogen and oxygen in the compressed air to generate electric power, and the generated power is supplied to a motor for driving the electric vehicle.

The fuel cell cooling unit 10 is a distributable product. The parts of the fuel cell cooling system 100 other than the fuel cell cooling unit 10 (i.e., radiator 110, piping 122, 124, etc.) are components connected later to the fuel cell cooling unit 10.

The fuel cell cooling unit 10 has a heat exchanger 30 and a first refrigerant circulation path 40. The heat exchanger 30 has a first path 31 and a second path 32. The heat exchanger 30 exchanges heat between the first path 31 and the second path 32. The first refrigerant circulation path 40 is an annular path with refrigerant circulating inside. The first refrigerant circulation path 40 is constituted of the first path 31 of heat exchanger 30, piping 42, fuel cell path 22 inside the fuel cell 20, and piping 44. The piping 42 connects the downstream end of the first path 31 to the upstream end of the fuel cell path 22. The piping 44 connects the downstream end of the fuel cell path 22 to the upstream end of the first path 31. A pump 50 is provided between the piping 44 and the first path 31. The pump 50 pumps the refrigerant from the piping 44 toward the first path 31. When the pump 50 operates, the refrigerant flows in the order of first path 31, piping 42, fuel cell path 22, and piping 44. In other words, the refrigerant circulates in the first refrigerant circulation path 40.

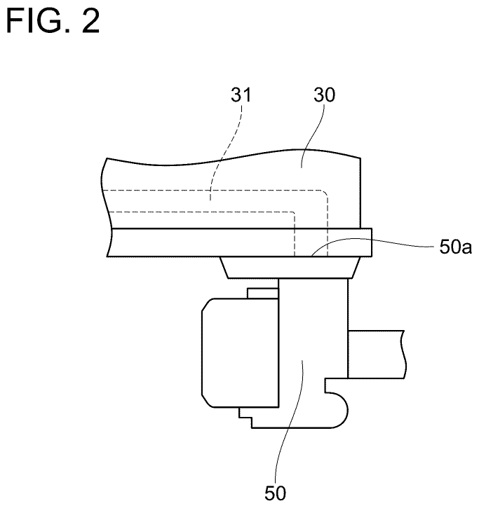

FIG. 2 illustrates the connection between the pump 50 and the heat exchanger 30 (i.e., the upstream end of the first path 31). As illustrated in FIG. 2, a discharge port 50a of the pump 50 is connected to the upstream end of the first path 31 by a flange connection. Although not illustrated, a gasket is placed on a sealing surface between the pump 50 and the heat exchanger 30 to prevent refrigerant leakage. Generally, the discharge port of the pump is connected to the heat exchanger via a rubber hose. In this case, the discharge pressure of the pump is limited due to the low pressure resistance of the rubber hose. In contrast, if the discharge port 50a of the pump 50 is connected to heat exchanger 30 (i.e., the first path 31) by a flange connection as illustrated in FIG. 2, the discharge pressure of the pump 50 can be increased because of the high strength of the connection. By increasing the discharge pressure of the pump 50, the suction side pressure of the pump 50 is also increased, thereby suppressing cavitation and crushing of the piping 44 (e.g., rubber hose) due to negative pressure. Thus, the pressure range over which the pump 50 can operate can be expanded by using a flange connection.

The frame of the body of the electric vehicle is used as an electrical grounding point. The housing of the heat exchanger 30 and the housing of the pump 50 are connected (i.e., grounded) to the frame of the electric vehicle by a ground wire. The fuel cell 20, on the other hand, is insulated from the frame of the electric vehicle because it is the power source. Therefore, the fuel cell 20 must be insulated from the heat exchanger 30 and the pump 50. In the fuel cell cooling unit 10, the piping 42 and 44 are made of insulating material (e.g., rubber hose). In the fuel cell cooling unit 10, the conductivity of the refrigerant flowing in the first refrigerant circulation path 40 is low. Therefore, the fuel cell 20 is insulated from the heat exchanger 30 and the pump 50.

As illustrated in FIG. 1, the fuel cell cooling unit 10 includes a parallel path 62 and an ion exchanger 60. The parallel path 62 is connected to the first refrigerant circulation path 40 at positions upstream and downstream of the heat exchanger 30. The parallel path 62 is connected in parallel to the fuel cell path 22. The ion exchanger 60 is provided in the parallel path 62. The parallel path 62 is not provided with a valve. Therefore, whenever the pump 50 is operating and the refrigerant is circulating in the first refrigerant circulation path 40, the refrigerant flows in the fuel cell path 22 and the parallel path 62. The ion exchanger 60 removes ions from the refrigerant flowing in the parallel path 62. Ions are eluted into the refrigerant in the first refrigerant circulation path 40 from components of the first refrigerant circulation path 40 (i.e., piping, etc.). By removing ions from the refrigerant, the ion exchanger 60 suppresses the increase in ion concentration in the refrigerant. This suppresses the increase in conductivity of the refrigerant in the first refrigerant circulation path 40 and maintains the insulation of the fuel cell 20 with respect to the heat exchanger 30 and pump 50.

The fuel cell cooling unit 10 includes a reservoir tank 70. The reservoir tank 70 is connected to the first refrigerant circulation path 40 at positions upstream and downstream of the heat exchanger 30. Surplus refrigerant in the first refrigerant circulation path 40 is stored in the reservoir tank 70.

A portion of the second path 32 of the heat exchanger 30 that is upstream of the heat exchanger 30 is constituted of piping 32a. A portion of the second path 32 of the heat exchanger 30 that is downstream of the heat exchanger 30 is constituted of piping 32b. The piping 32a and 32b are constituted of a rigid material such as resin. The fuel cell cooling unit 10 includes a bypass path 82 and an intercooler 80. The bypass path 82 connects the piping 32a and the piping 32b. The intercooler 80 cools the compressed air supplied to the fuel cell 20 by heat exchange with the refrigerant flowing in the bypass path 82. The piping 32a is provided with a connection structure that allows external piping to be connected and disconnected. The piping 32b is provided with a connection structure that allows external piping to be connected and disconnected. As these connection structures, bolt-type connection structures and connector-type connection structures can be used. The bolt-type connection structures connect piping by fastening bolt(s). The connector-type connection structures are connection structures in which the piping is switched between an engaged state and an unengaged state by the movement of movable member(s). The pump 150 to be described later is detachably connected to the piping 32a. The piping 122 to be described later is detachably connected to the piping 32b.

The fuel cell cooling system 100 includes, in addition to the fuel cell cooling unit 10, a radiator 110, piping 122, 124, and the pump 150. The upstream end of the piping 122 is connected to the downstream end of the second path 32 of the heat exchanger 30 (i.e., the connection structure provided in the piping 32b). The downstream end of the piping 122 is connected to the upstream end of the refrigerant path provided inside the radiator 110 (hereinafter referred to as the radiator path). The downstream end of the radiator path is connected to the upstream end of the piping 124. The downstream end of the piping 124 is connected to an inlet port of the pump 150. A discharge port of the pump 150 is connected to the upstream end of the second path 32 of the heat exchanger 30 (i.e., the connection structure in the piping 32a). The radiator path, piping 122 and 124, pump 150, and second path 32 form a second refrigerant circulation path 140. The second refrigerant circulation path 140 is an annular path with refrigerant circulating inside. The conductivity of the refrigerant in the second refrigerant circulation path 140 is higher than the conductivity of the refrigerant in the first refrigerant circulation path 40. The pump 150 pumps the refrigerant from the piping 124 toward the second path 32. When the pump 150 operates, the refrigerant flows in the order of second path 32, piping 122, radiator path, and piping 124. In other words, the refrigerant circulates in the second refrigerant circulation path 140. When the refrigerant circulates in the second refrigerant circulation path 140, the refrigerant also flows in the bypass path 82, allowing the intercooler 80 to operate.

The fuel cell cooling system 100 includes a reservoir tank 170. The reservoir tank 170 is connected to the second refrigerant circulation path 140 at positions upstream and downstream of the heat exchanger 30. Surplus refrigerant in the second refrigerant circulation path 140 is stored in the reservoir tank 170.

An air conditioning circuit 200 is connected to the piping 122. The air conditioning circuit 200 includes an air conditioning refrigerant circulation path 210, a pump 220, a water heater 230, a heater core 240, and a valve 250. When the valve 250 is opened, the refrigerant flows between the second refrigerant circulation path 140 and the air conditioning refrigerant circulation path 210. The air conditioning circuit 200 regulates the temperature in the cabin of the electric vehicle through heat exchange with the refrigerant in the air conditioning refrigerant circulation path 210.

The fuel cell cooling system 100 is activated when the electric vehicle is in use. When the fuel cell cooling system 100 is activated, the pump 150 circulates the refrigerant in the second refrigerant circulation path 140 and the pump 50 circulates the refrigerant in the first refrigerant circulation path 40. The radiator 110 cools the refrigerant circulating in second refrigerant circulation path 140. Therefore, the refrigerant cooled by the radiator 110 flows in the second path 32 of the heat exchanger 30. The heat exchanger 30 cools the refrigerant in the first path 31 by heat exchange between the refrigerant in the second path 32 and the refrigerant in the first path 31. Thus, the refrigerant cooled by the heat exchanger 30 flows into the fuel cell path 22 of the fuel cell 20. This cools the fuel cell 20.

The conductivity of the refrigerant in the first refrigerant circulation path 40 is lower than the conductivity of the refrigerant in the second refrigerant circulation path 140. The ion exchanger 60 is provided in the first refrigerant circulation path 40 via the parallel path 62. As described above, whenever the refrigerant is circulating in the first refrigerant circulation path 40, the refrigerant also flows in the parallel path 62, and ions in the refrigerant are removed by the ion exchanger 60. Thus, the increase in conductivity of the refrigerant in the first refrigerant circulation path 40 is suppressed. Therefore, high insulation is ensured between the fuel cell 20 and the heat exchanger 30 (i.e., the ground point). On the other hand, since there is no ion exchanger in the second refrigerant circulation path 140, the conductivity of the refrigerant in the second refrigerant circulation path 140 is high. Therefore, the insulation resistance between the radiator 110 and the heat exchanger 30 is low. However, the insulation between the radiator 110 and the fuel cell 20 is ensured because the heat exchanger 30 and the fuel cell 20 are insulated.

By dividing the refrigerant circulation path into the first refrigerant circulation path 40 and the second refrigerant circulation path 140 and by making the conductivity of the refrigerant in the second refrigerant circulation path 140 higher than that of the refrigerant in the first refrigerant circulation path 40, the following aspects can be achieved.

A first aspect of the present disclosure is that the ion concentration in the refrigerant in the first refrigerant circulation path 40 tends not to increase. When the radiator and the fuel cell are connected by a single refrigerant circulation path, the refrigerant circulation path becomes long. In contrast, when the first refrigerant circulation path 40 and the second refrigerant circulation path 140 are provided independently, the first refrigerant circulation path 40 and the second refrigerant circulation path 140 will each be shorter. The shorter first refrigerant circulation path 40 results in lower elution of ions from the components of the first refrigerant circulation path 40 (i.e., piping, etc.) into the refrigerant. In general, the radiator is the component most prone to leaching of ions into the refrigerant. In the fuel cell cooling system 100, since the radiator 110 is separated from the first refrigerant circulation path 40, elution of ions from the radiator 110 into the refrigerant in the first refrigerant circulation path 40 does not occur. Furthermore, since the intercooler 80 and the air conditioning circuit 200 are also separated from the first refrigerant circulation path 40 in the fuel cell cooling system 100, elution of ions from the intercooler 80 and the air conditioning circuit 200 to the refrigerant in the first refrigerant circulation path 40 also does not occur. Therefore, the ion concentration in the refrigerant in the first refrigerant circulation path 40 tends not to increase. Therefore, the amount of ions removed by the ion exchanger 60 is also reduced, and the ion exchanger 60 can therefore be made smaller.

A second aspect of the present disclosure is reduced component costs. In the fuel cell cooling system 100, insulation is ensured between the fuel cell 20 and the heat exchanger 30, so there is no need to ensure insulation between the radiator 110 and the heat exchanger 30. Therefore, a refrigerant with high conductivity can be used as the refrigerant in the second refrigerant circulation path 140. In addition, since there is no need to control the conductivity of the refrigerant in the second refrigerant circulation path 140, materials of the components of the second refrigerant circulation path 140 (i.e., piping, etc.) can be selected without considering the elution of ions. Thus, a wider range of refrigerants and components of the second refrigerant circulation path 140 can be selected, allowing the use of less expensive components.

A third aspect of the present disclosure is reduced cleaning costs. When a refrigerant with low conductivity is used, the inside of its piping must be cleaned before the vehicle is shipped. This is to prevent ions from leaching into the refrigerant. In the fuel cell cooling system 100, only the first refrigerant circulation path 40 uses a low conductivity refrigerant, so the inside of the second refrigerant circulation path 140 does not need to be cleaned. Since the first refrigerant circulation path 40 is short and the first refrigerant circulation path 40 is not connected to the radiator 110, the intercooler 80, the air conditioning circuit 200, etc., the first refrigerant circulation path 40 can be easily cleaned. Thus, the costs for cleaning before shipment can be reduced.

Next, the aspects achieved by the fuel cell cooling unit 10 will be described. As mentioned above, the fuel cell cooling system 100 is manufactured by adding the radiator 110, the piping 122, 124, etc. to the fuel cell cooling unit 10, which is configured for distribution. In other words, the fuel cell cooling unit 10 is designed by a manufacturer of the fuel cell cooling unit 10, and the second refrigerant circulation path 140 is designed by a user of the fuel cell cooling unit 10 (i.e., a manufacturer of the electric vehicle). Since insulation is ensured between the fuel cell 20 and the heat exchanger 30 in the fuel cell cooling unit 10, the manufacturer of the electric vehicle can design the second refrigerant circulation path 140 without considering insulation. Further, since the second path 32 of the heat exchanger 30 is separated from the first refrigerant circulation path 40, the manufacturer of the electric vehicle can design the second refrigerant circulation path 140 without considering pressure effects from the second refrigerant circulation path 140 to the first refrigerant circulation path 40. Thus, the fuel cell cooling unit 10 allows a variety of designs as the second refrigerant circulation path 140. In other words, by using the fuel cell cooling unit 10, the fuel cell can be used in a variety of forms.

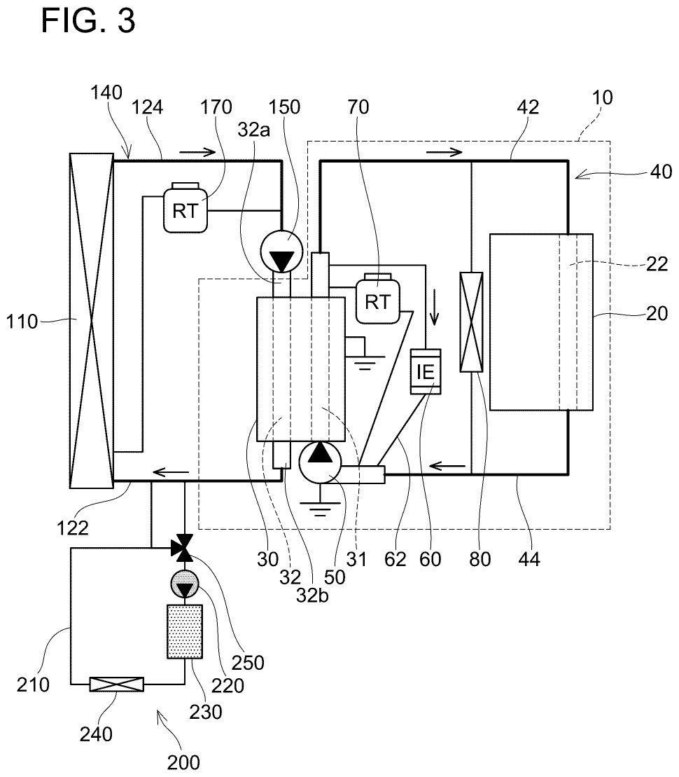

Since the intercooler 80 is installed on the second refrigerant circulation path 140 side in the embodiment described above, coordinated control of the pump 50 and the pump 150 is required to control cooling of the fuel cell 20 and the intercooler 80. Therefore, the intercooler 80 may be installed on the first refrigerant circulation path 40 side as illustrated in FIG. 3. According to this configuration, the cooling of fuel cell 20 and the intercooler 80 can be controlled by controlling only the pump 50.

Although the above-described embodiment describes a fuel cell cooling system installed in an electric vehicle, the technology disclosed herein may be applied to fuel cell cooling systems used in applications other than electric vehicles.

Specific examples of the present disclosure have been described in detail, however, these are mere exemplary indications and thus do not limit the scope of the claims. The art described in the claims include modifications and variations of the specific examples presented above. Technical features described in the description and the drawings may technically be useful alone or in various combinations, and are not limited to the combinations as originally claimed. Further, the art described in the description and the drawings may concurrently achieve a plurality of aims, and technical significance thereof resides in achieving any one of such aims.

What is claimed is:

1. A fuel cell cooling unit, comprising:
a first refrigerant circulation path in which refrigerant circulates,
a fuel cell configured to be cooled by the refrigerant flowing in the first refrigerant circulation path; and
a heat exchanger comprising a first path and a second path, the first path being a part of the first refrigerant circulation path, and the heat exchanger being configured to exchange heat between the first path and the second path,
wherein a connection structure allowing a pipe to be connected and disconnected is provided at each of an upstream end and a downstream end of the second path.

2. The fuel cell cooling unit of claim 1, further comprising:
a parallel path connected in parallel to a fuel cell path which is a portion of the first refrigerant circulation path extending through the fuel cell; and
an ion exchanger configured to remove ions from the refrigerant in the parallel path;
wherein the refrigerant flows in the fuel cell path and the parallel path whenever the refrigerant is circulating in the first refrigerant circulation path.

3. The fuel cell cooling unit of claim 1, further comprising a pump configured to circulate the refrigerant in the first refrigerant circulation path,
wherein a discharge port of the pump is connected to an upstream end of the first path by a flange connection.

4. The fuel cell cooling unit of claim 1, further comprising:
a bypass path connecting an upstream portion of the second path with respect to the heat exchanger and a downstream portion of the second path with respect to the heat exchanger; and
an intercooler provided in the bypass path and configured to cool air supplied to the fuel cell.

5. A fuel cell cooling system, comprising:
a first refrigerant circulation path in which refrigerant circulates;
a fuel cell configured to be cooled by the refrigerant flowing in the first refrigerant circulation path;
a second refrigerant circulation path in which refrigerant circulates;
a radiator configured to cool the refrigerant flowing in the second refrigerant circulation path; and
a heat exchanger comprising a first path and a second path, the first path being a part of the first refrigerant circulation path, the second path being a part of the second refrigerant circulation path, and the heat exchanger being configured to exchange heat between the first path and the second path,
wherein electrical conductivity of the refrigerant in the second refrigerant circulation path is higher than electrical conductivity of the refrigerant in the first refrigerant circulation path.
